(19) United States
(12) Patent Application Publication
(10) Pub. No.: US 2005/0228987 A1
(43) Pub. Date: Oct. 13, 2005

(54) Method and apparatus for providing audit certificate for investor-relations-information disclosed in computer network

(75) Inventor: Sachiko Wada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/148,232

(22) Filed: Jun. 9, 2005

Related U.S. Application Data
(63) Continuation of application No. PCT/JP03/06419, filed on May 22, 2003.

(51) Int. Cl. H04L 9/00

(52) U.S. Cl. 713/156

(57) ABSTRACT

A method, which is for a server that provides an audit certificate for investor-relations-information to a disclosure server of a public company in cooperation with an audit server, includes: receiving an audit request for an audit of the investor-relations-information from the public company; sending the audit request received from the public company to the audit server; receiving the audit certificate including a result of the audit from the audit server; receiving an audit certificate request for the audit certification from the disclosure server; and sending the audit certificate to the disclosure server in response to the audit certificate request.

### BACKGROUND OF THE INVENTION

1) Field of the Invention

The present invention relates to a technology for providing audit certificate for investor-relations-information on a disclosure server of a public company.

2) Description of the Related Art

Conventionally, a way that a general investor knows company accounting information of a public company includes reviewing a securities report or a semiannual report issued by Ministry of Finance, Financial Services of Agency, or Stock Exchange. Since the securities report or the semiannual report is issued by Ministry of Finance, Financial Services of Agency, or Stock Exchange, reliability thereof is high. When a public company self-discloses its securities report, a general investor can review the content thereof. A general investor determines a stock price of each public company based upon the contents.

As a method for supporting a mechanism for preparation of public offering of stocks, there is a conventional art disclosed in Japanese Patent Laid-Open No. 2003-44673.

In the conventional art, however, a conventional company accounting information disclosure model includes such a problem that a proper stock price formation can not be achieved. In other words, a public company can not be evaluated at its optimal time by general investors. Conventionally, a regular information disclosure is performed for each year or for each half year, which does not provide sufficient material for general investors' determination. There is such a problem that, since self-disclosure information performed by the public company may include intended change in contents or description or clerical error, it can not be trusted by general investors sufficiently. In other words, since the self-disclosure information is non-audited information, general investors can not make determination about appropriateness, and even if information opened as audited information by a public company is different from information actually audited, general investors can not have means or way for confirming such a fact. Further, since audit performed by an auditing corporation or a certified public accountant ordinarily requires several weeks or several months, it is difficult to issue an audit report at timing for each month in many cases.

### SUMMARY OF THE INVENTION

It is an object of the present invention to at least solve the problems in the conventional technology.

A server according to an aspect of the present invention is a server for providing an audit certificate for investor-relations-information to a disclosure server of a public company in cooperation with an audit server. The server includes: an audit-request-receiving unit that receives an audit request for an audit of the investor-relations-information from the public company; an audit-request-sending unit that sends the audit request received from the public company to the audit server; an audit-certificate-receiving unit that receives the audit certificate including a result of the audit from the audit server; an audit-certificate-request-receiving unit that receives an audit certificate request for the audit certification from the disclosure server; and an audit-certificate-sending unit that sends the audit certificate to the disclosure server in response to the audit certificate request.

A disclosure server according to another aspect of the present invention is a disclosure server for providing investor-relations-information of a public company to a client in cooperation with a server for providing an audit certificate for the investor-relations-information. The disclosure server includes: an audit-certificate-request-receiving unit that receives an audit certificate request for the audit certificate from the client; an audit-certificate-receiving unit that receives the audit certificate from the server; and an audit-certificate-sending unit that sends the audit certificate to the client in response to the audit certificate request.

A method according to still another aspect of the present invention is a method for a server that provides an audit certificate for investor-relations-information to a disclosure server of a public company in cooperation with an audit server. The method includes: receiving an audit request for an audit of the investor-relations-information from the public company; sending the audit request received from the public company to the audit server; receiving the audit certificate including a result of the audit from the audit server; receiving an audit certificate request for the audit certification from the disclosure server; and sending the audit certificate to the disclosure server in response to the audit certificate request.

A method according to still another aspect of the present invention is a method for a disclosure server that provides investor-relations-information of a public company to a client in cooperation with a server that provides an audit certificate for the investor-relations-information. The method includes: receiving an audit certificate request for the audit certificate from the client; receiving the audit certificate from the server; and sending the audit certificate to the client in response to the audit certificate request.

A computer-readable recording medium according to still another aspect of the present invention stores a computer program to cause the server to execute the above method.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram of a system including a reliability providing server according to an embodiment of the present invention;

FIG. 2 is a block diagram of each information processing apparatus included in the system;

FIG. 3 is a block diagram of the reliability providing server;

FIG. 4 is a diagram of an audit contract table in the reliability providing server;

FIGS. 5 to 7 are diagrams of a status table in the reliability providing server;

FIGS. 8A and 8B are diagrams of an access table in the reliability providing server;

FIGS. 9 and 10 are diagrams of an information disclosure table in a disclosure server included in the system;

FIGS. 11 and 12 are diagrams of a screen displayed on a client;

FIG. 13 is a diagram of a condition specifying file;

FIG. 14 is a diagram of a log file;

FIG. 15 is a diagram for explaining a reliability providing processing according to the present embodiment;

FIG. 16 is a flowchart of the reliability providing processing;

FIG. 17 is a diagram of an auditing system included in the system;

FIGS. 18 to 21 are diagrams of a screen displayed in the auditing system;

FIGS. 22 and 23 are flowchart of a processing performed by the reliability providing server; and

FIG. 24 is a flowchart of a processing performed by the disclosure server.

### DETAILED DESCRIPTION

Exemplary embodiments will be explained below in detail with reference to the accompanying drawings.

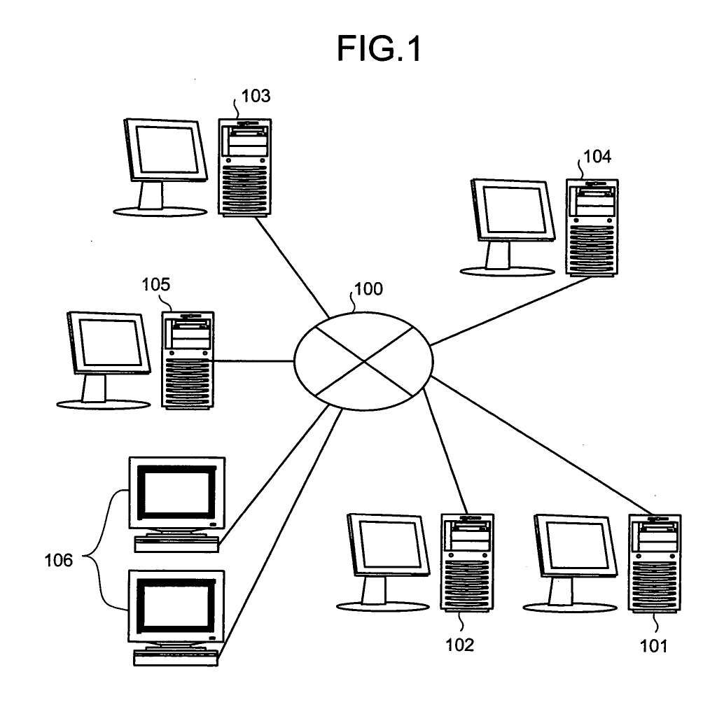

FIG. 1 is a diagram of a system including a reliability providing server according to an embodiment of the present invention. The entire system is constituted of a reliability providing server 101, an access information collecting system 102, an accounting system 103, an auditing system 104, a server for outside opening 105, and a client 106 for a general investor including such a mobile terminal apparatus as a personal computer, a portable telephone, or a personal digital assistance (PDA), where respective servers and/or respective systems are connected to one another via a network 100 such as an exclusive line including Internet, local area network (LAN), or wide area network (WAN).

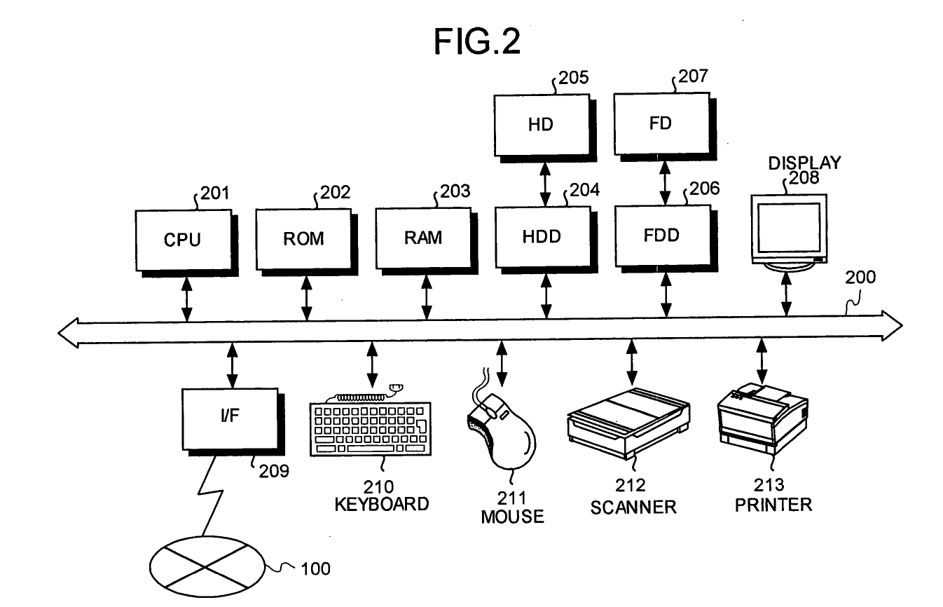

FIG. 2 is a block diagram of each information processing apparatus included in the system. The reliability providing apparatus (sever) includes a central processing unit (CPU) 201, a read only memory (ROM) 202, a random access memory (RAM) 203, a hard disc drive (HDD) 204, a hard disc (HD) 205, a flexible disc drive (FDD) 206, a flexible disc (FD) 207 that is one example of attachable/detachable recording medium, a display 208, an interface (I/F) 209, a keyboard 210, a mouse 211, a scanner 212, and a printer 213. Respective constituent elements are connected to one another by a bus 200.

The CPU 201 serves to control the entire of the respective servers and the respective systems. The ROM 202 stores programs such as a boot program therein. The RAM 203 is used as a work area for the CPU 201. The HDD 204 controls read/write of data to the HD 205 according to control performed by the CPU 201. The HD 205 stores data written under the control of the HDD 204.

The FDD 206 controls read/write of data to the FD 207 according to control of the CPU 201. The FD 207 stores data written according to control of the FDD 206 or reads data stored in the FD 207 to the information processing apparatus. The attachable/detachable recording medium may be a CD-ROM (CD-R, CD-RW), a magnetic optical (MO) disk, a digital versatile disk (DVD), or a memory card other than the FD 207. The display 208 displays a window (browser) regarding data such as document, image, or functional information, including a cursor, an icon, or a tool box. For example, the display may be a cathode ray tube (CRT) display, a thin-film-transistor (TFT) liquid crystal display, a plasma display, or the like.

The I/F (interface) 209 is connected to the network 100 through a communication line and it is connected to another server or another information apparatus via the network 100. The I/F 209 serves as an interface between the network 100 and interior apparatuses in the reliability providing apparatus shown in FIG. 1 and controls input/output of data to/from another server or information terminal apparatus. The I/F 209 is a modem or a LAN adapter, for example.

The keyboard 210 is provided with keys for inputting characters, numerals, respective instructions or commands, or the like to perform data input. The keyboard may be an input pad of a touch panel type or a ten key keyboard. The mouse 211 is used for movement of a cursor, a range selection, movement or size change of a window or the like. A track ball, a joy stick, a cross key, a jog dial or the like may be used if it has a similar function as a pointing device.

The scanner 212 optically reads an image to take image data into the information processing apparatus. The printer 213 prints image data and document data. For example, the printer may be a laser printer, an inkjet printer or the like.

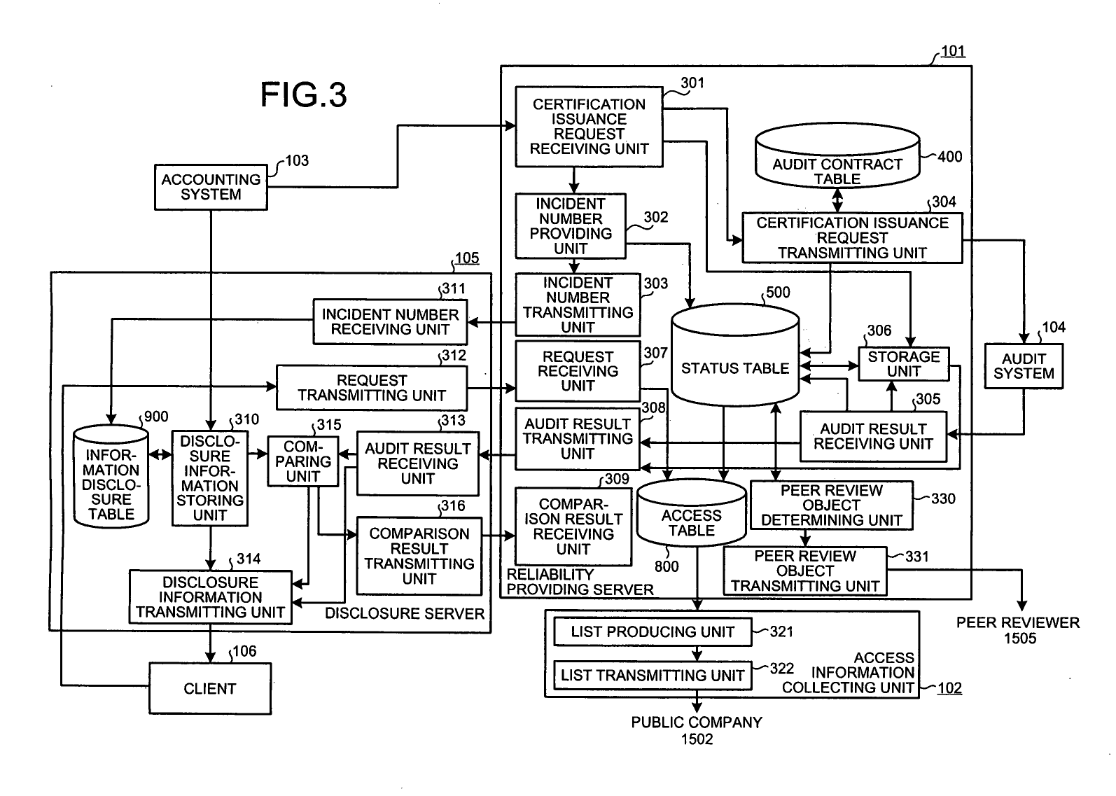

FIG. 3 is a block diagram of the reliability providing server 101. The reliability providing server 101 includes a certification issuance request receiving unit 301, an incident number providing unit 302, an incident number transmitting unit 303, a certification issuance request transmitting unit 304, a audit result receiving unit 305, a storage unit 306, a request receiving unit 307, an audit result transmitting unit 308, a comparison result receiving unit 309, a peer review object determining unit 330, a peer review object transmitting unit 331, a audit contract table 400, a status table 500, and an access table 800.

The certification issuance request receiving unit 301 receives certification issuance request that requires issuance of an audit certification and is disclosure information where a public company discloses contents thereof via the network 100. The incident number providing unit 302 provides the certification issuance request received by the certification issuance request receiving unit 301 to a serial incident number. The incident number transmitting unit 303 transmits information about the incident number provided by the incident number providing unit 302 to the disclosure server 105.

The certification issuance request transmitting unit 304 transmits certification issuance request received by the certification issuance request receiving unit 301 to the audit system 104. At that time, an audit system 104 of a transmission destination is specified using the audit contract table 400 described later. The audit result receiving unit 305 receives audit result about an audit result from the audit system 104. The storage unit 306 stores the certification issuance request and stores (registers) the audit result received by the audit result receiving unit 305. Information indicating where the information has been stored in the storage unit 306 is written in the status table 500. Contents of the status table 500 will be explained in detail later.

The request receiving unit 307 receives request for the audit result from the disclosure server 105, specifically, for example, information about an incident number. The audit result transmitting unit 308 transmits audit result stored in the storage unit 306 to the disclosure server 105, when it receives request from the disclosure server 105. Alternately, when the audit result has not been received by the audit result receiving unit 305 yet, the audit result transmitting unit 308 transmits information indicating such a fact to the disclosure server 105. When transmitting the audit result stored in the storage unit 306, the audit result transmitting unit 308 may transmit the certification issuance request stored in the storage unit 306 together with the audit result. The certification issuance request is used for confirming coincidence with disclosed contents in comparison performed in the disclosure server 105.

The comparison result receiving unit 309 receives information on the result obtained by performing comparison about whether the disclosed contents and the contents of the certification issuance request are coincident with each other in the disclosure server 105. Received information is accumulated for each public company, and when the result indicating inconsistency occurs predetermined times or more, the received information is used to perform a processing such as alarming to the public company.

The peer review object determining unit 330 determines log information which is an object for peer review from log information including audit result. The peer review object transmitting unit 331 transmits related information including log information determined by the peer review object determining unit 330 to a peer reviewer 1505. Detailed contents of the peer reviewer 1505 will be described later.

Functions of the respective constituent units can be realized by the CPU 201 performing programs stored in the ROM 202, the RAM 203, the HD 205, the FD 207 or the like, or the I/F 209 shown in FIG. 2.

The disclosure server 105 includes a disclosure information storing unit 310, an incident number receiving unit 311, a request transmitting unit 312, an audit result receiving unit 313, a disclosure information transmitting unit 314, a comparing unit 315, a comparison result transmitting unit 316, and an information disclosure table 900.

The disclosure information storing unit 310 stores disclosure information through which public companies disclose contents thereof and such that the disclosure information can be browsed via the network 100. The incident number receiving unit 311 receives an incident number provided for each disclosure information from the reliability providing server 101 providing reliability to disclosure information through which a public company discloses contents. The incident number received by the incident number receiving unit 311 is stored to correspond to the disclosure information. Information about where the information has been stored in the disclosure information storing unit 310 is written in the information disclosure table 900. Detailed contents of the information disclosure table 900 will be described later.

When receiving a browsing request to the disclosure information stored in the storage unit 306 from a client 106 of a general investor via the network 100, the request transmitting unit 312 transmits request requesting audit result regarding the audit result to the reliability providing server 101 providing reliability to the disclosure information. The information requested includes the incident number.

The audit result receiving unit 313 receives the audit result transmitted from the reliability providing server 101 in response to the request transmitted from the request transmitting unit 312. Alternately, when the reliability providing server 101 has not received the audit result yet, the audit result receiving unit 313 receives a notice indicating such a fact from the reliability providing server 101. The disclosure information transmitting unit 314 transmits the audit result received by the audit result receiving unit 313 to the client 106 issuing the browsing request together with the disclosure information stored in the disclosure information storing unit 310.

The comparing unit 315 performs comparison about whether the contents of the certification issuance request and the disclosure information stored in the disclosure information storing unit 310 are coincident with each other, when the audit result receiving unit 313 receives the audit result along with the certification issuance request. The disclosure information transmitting unit 314 transmits the audit result as well as the disclosure information stored in the disclosure information storing unit 310 to the client 106 that has issued the browsing request based upon the result obtained by comparison in the comparing unit 315. Further, the comparison result transmitting unit 316 transmits information on the result obtained by comparison in the comparing unit 315 to the reliability providing server 101.

Specifically functions of the respective constituent units can be realized by the CPU 201 performing programs stored in the ROM 202, the RAM 203, the HD 205, the FD 207 shown in FIG. 2 or the like, or the I/F 209 shown in FIG. 2.

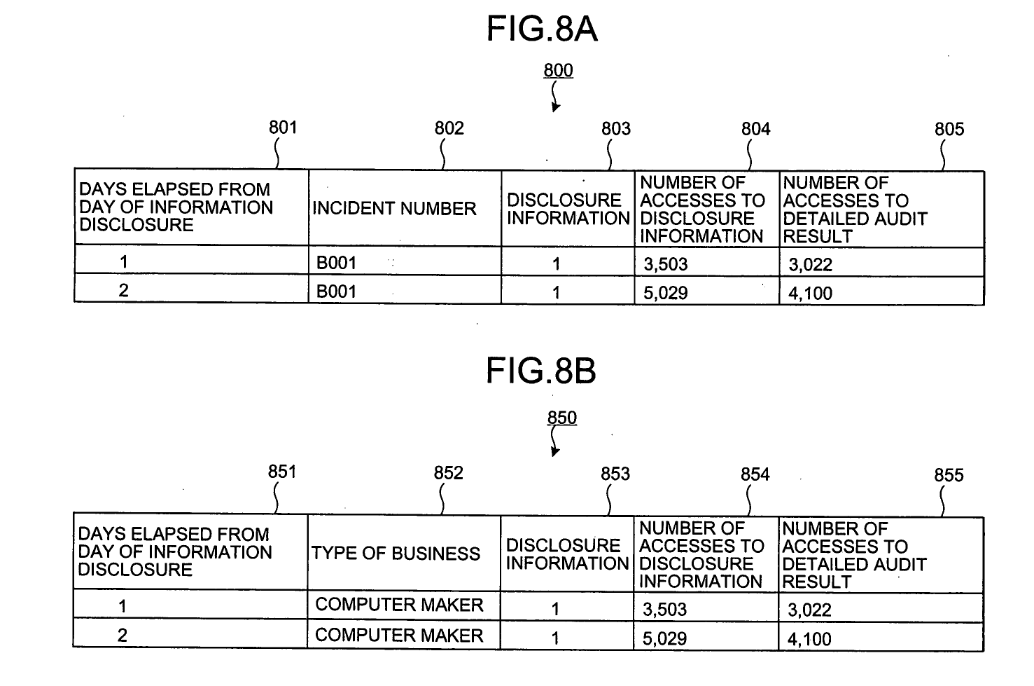

The access information collecting unit 102 includes a list producing unit 321 and a list transmitting unit 322. The list producing unit 321 periodically produces a list including contents, for example, as shown in FIG. 8 described later regarding the contents of the access table 800. The list transmitting unit 322 transmits a list produced by the list producing unit 321 to a public company. Functions of the respective constituent units can be realized by the CPU 201 performing programs stored in the ROM 202, the RAM 203, the HD 205, the FD 207 or the like, or the I/F 209 shown in FIG. 2.

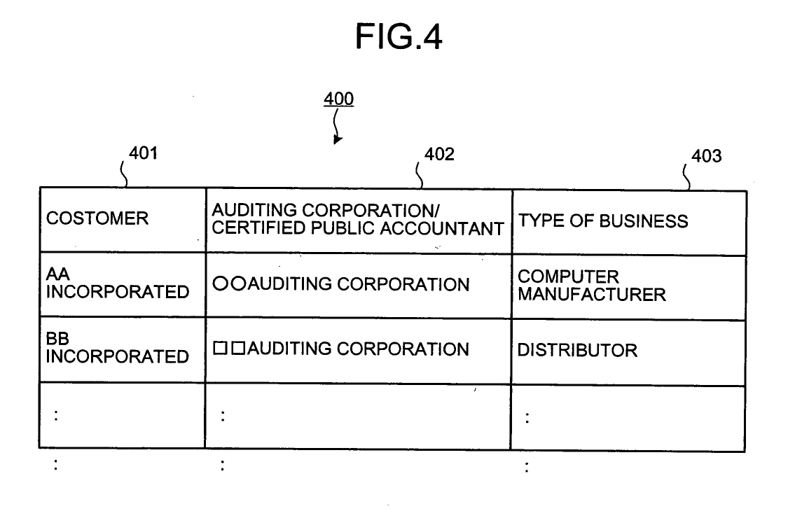

FIG. 4 is a diagram of an audit contract table 400 in the reliability providing server 101. The audit contract table 400 is a table showing which auditing corporations or certified public accountants are employed by (audit-contracted with) respective customers (public company 1502 described later). The table 400 includes an item 401 indicating “customer”, an item 402 indicating “auditing corporation/certified public accountant”, and an item 403 indicating “type of business”, which are associated with one another.

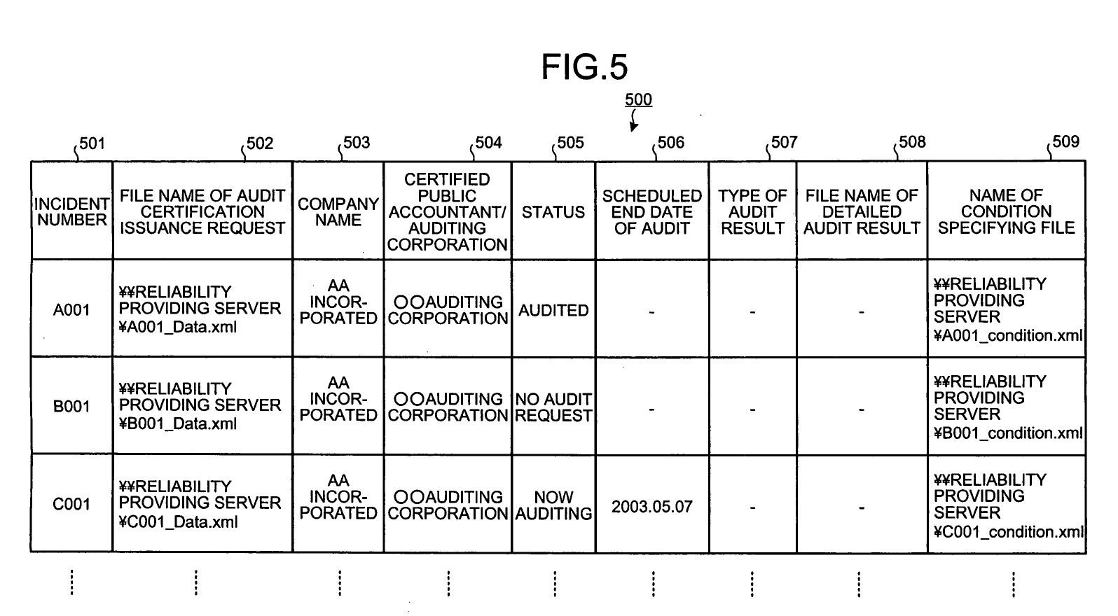

FIGS. 5 to 7 are diagrams of the status table 500 in the reliability providing server 101. The status table 500 includes an item 501 indicating “incident number”, an item 502 indicating “audit certification issuance request file name”, an item 503 indicating “company name”, an item 504 indicating “certified public accountant/auditing corporation”, an item 505 indicating “status”, an item 506 indicating “scheduled end date of audit”, an item 507 indicating “type of audit result”, an item 508 indicating “file name of detailed audit result”, and an item 509 indicating “name of condition specifying file”, which are associated with one another.

The item 501 indicating “incident number” is stored with an incident number constituted of a serial number. The item 502 indicating “file name of audit certification issuance request” is stored with a file name of a file in which contents of an audit certification issuance request have been described. The audit certification issuance request file is present in the reliability providing server 101. The item 503 indicating “company name” is stored with names of public companies that are customers. The item 504 indicating “certified public accountant/auditing corporation” is stored with names of auditing corporations or certified public accountants employed by (audit-contracted with) public companies based upon the audit contract table 400 shown in FIG. 4.

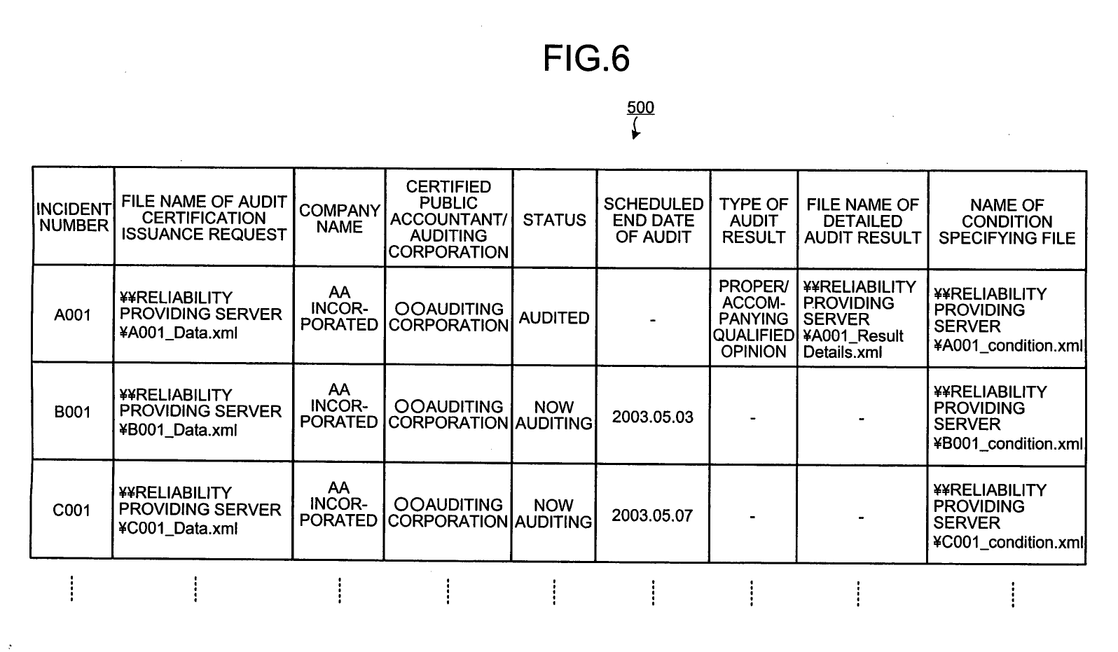

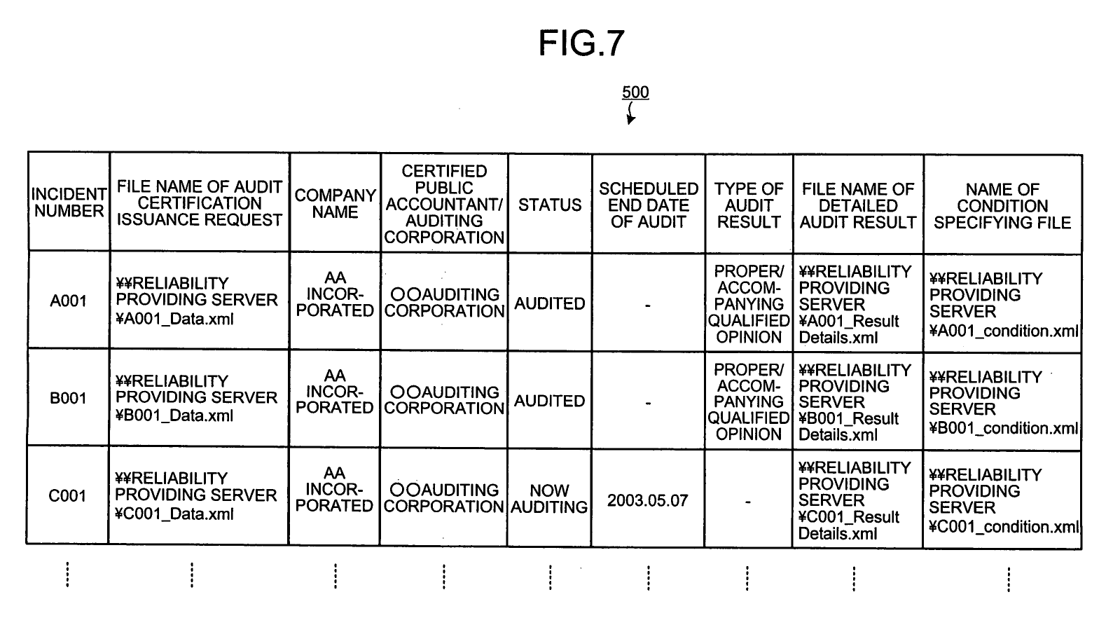

The item 505 indicating “status” is stored with information about the status of audit. As shown in FIG. 6 or 7, for example, such a status as “audited” or “now auditing” is stored in the item 505. The item 506 indicating “scheduled end date of audit” is stored with information about a scheduled end date of audit when the item 505 indicating “status” shows “now auditing”. The item 507 indicating “type of audit result” is stored with a type of audit result. As shown in FIG. 6 or 7, for example, “proper/accompanying qualified opinion” is stored in the item 507 as the type of audit result. The item 508 indicating “file name of detailed audit result” is stored with a name of a file where detailed audit result has been described. The detailed audit result file is present in the reliability providing server 101. The item 509 indicating “name of condition specifying file” is stored with a file name of a file where contents for specifying conditions has been described. The condition specifying file is present in the reliability providing server 101.

FIGS. 8A and 8B are diagrams of an access table (access counter) of the access information collecting system 102 in the reliability providing server 101. The access table 800 serving as an access counter includes an item 801 indicating “days elapsed from information disclosure day”, an item 802 indicating “incident number”, an item 803 indicating “disclosure information”, an item 804 indicating “the number of accesses to disclosure information”, and an item 805 indicating “the number of accesses to detailed audit result”, which are associated with one another. The access table 850 serving as an access counter includes an item 851 indicating “days elapsed from information disclosure day”, an item 852 indicating “type of business”, an item 853 indicating “disclosure information”, an item 854 indicating “number of accesses to disclosure information”, and an item 855 indicating “the number of accesses to detailed audit result”, which are associated with one another.

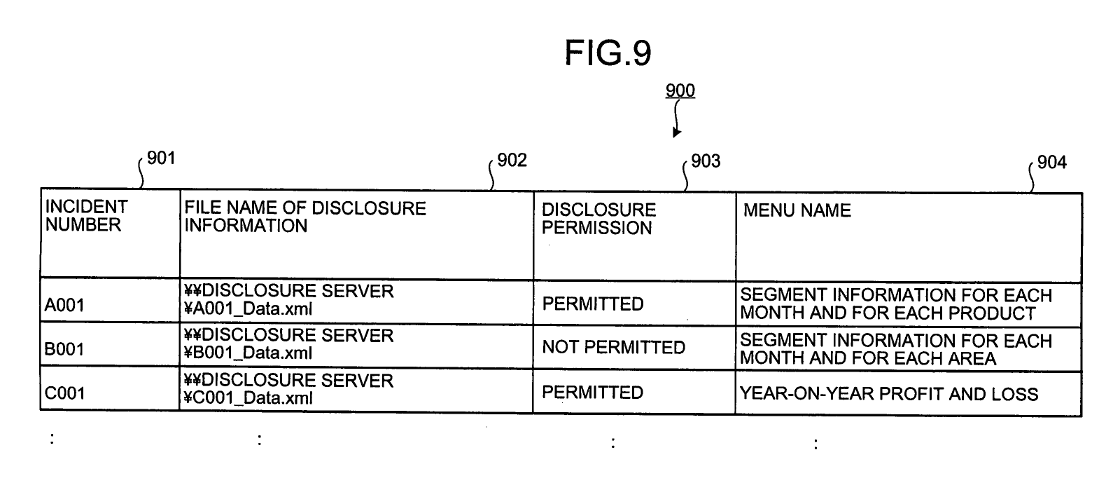

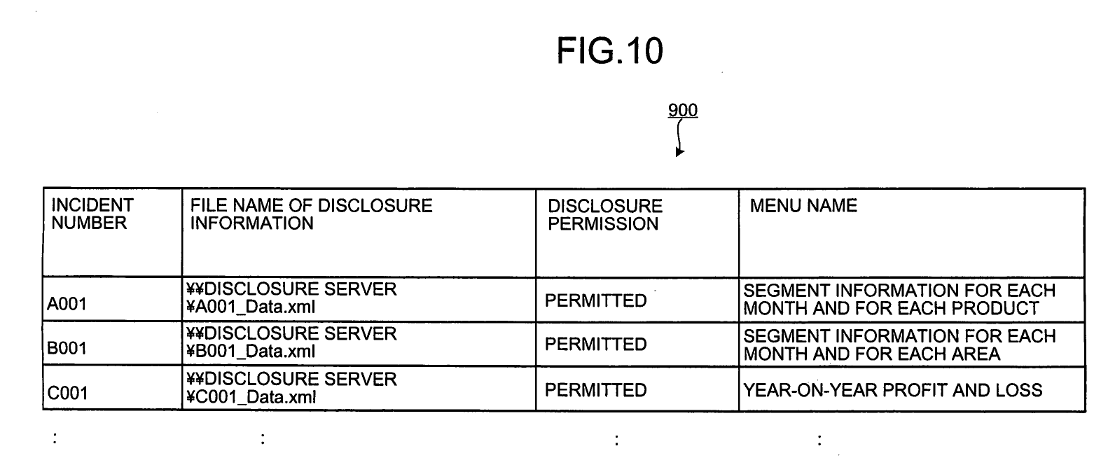

FIGS. 9 and 10 are diagrams of an information disclosure table in the disclosure server 105. An information disclosure table 900 includes an item 901 indicating “incident number”, an item 902 indicating “file name of disclosure information”, an item 903 indicating “disclosure permission”, and an item 904 indicating “menu name”, which are associated with one another. When the item 903 indicating “disclosure permission” shows “permitted”, the information can be browsed by general investors 1504, but when the item 903 shows “not permitted”, the information can not be browsed by general investors. Therefore, operation about whether the information should be a browsing object can be performed by rewriting data in the item 903, so that even information that has not been audited yet can be set to a disclosure object according to intention of each public company 1502. Specifically, in the record with the incident number “B001”, the item 903 shows “not permitted” in FIG. 9. On the other hand, the item 903 shows “permitted” in FIG. 10, and the information can be browsed by general investors 1504 at this time.

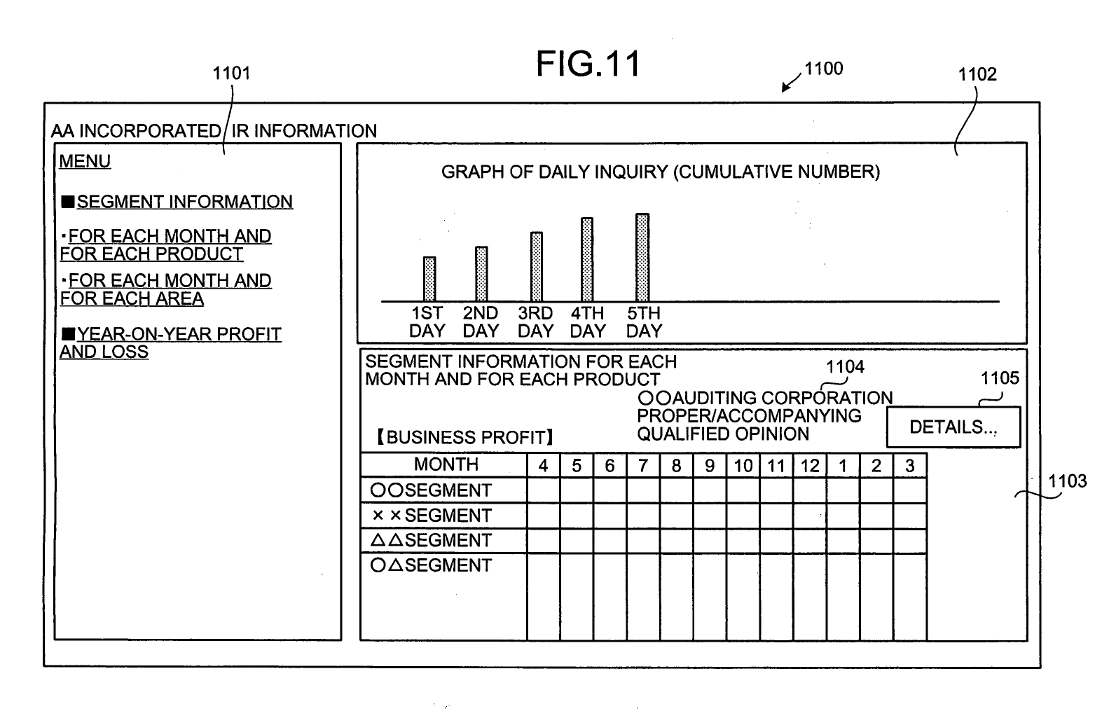

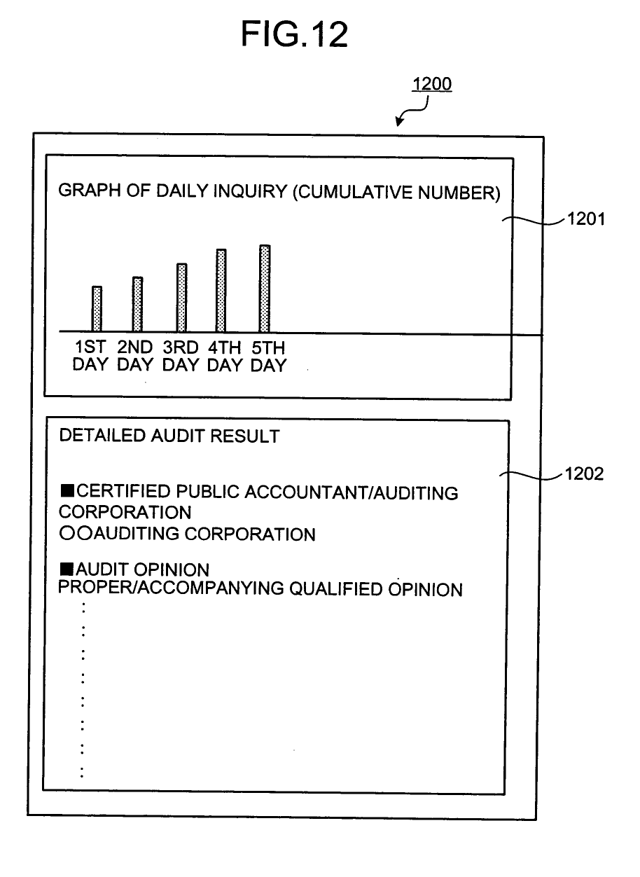

FIGS. 11 and 12 are diagrams of a screen displayed on the client 106. A list of a menu (a menu coincident with contents stored in the item 904 indicating “menu name” of the information disclosure table 900 shown in FIGS. 9 and 10) to be browsed is displayed in a display region 1101 on the left side of a display screen 1100 showing IR information for each public company.

A graph of the number of inquiries for each day is graphically displayed on a right upper half display region 1102. Segment information (“segment information for each month and for each product in FIG. 11) selected through the menu is displayed on a right lower half display region 1103. A status of audit of the information is displayed on a display field 1104. In the display field 1104, “OO AUDITING CORPORATION: PROPER/ACCOMPANYING QUALIFIED OPINION” is displayed. In a public company currently put during auditing, “NOW AUDITING” together with scheduled end date of audit is displayed on the display field 1104. When a “detail button” 1105 is clicked, a display screen shown in FIG. 12 is displayed.

An upper half display region 1201 is a counter for detailed audit result like the right upper half display region 1102 shown in FIG. 11. Information (detailed audit result) is displayed on a lower half display region 1202 shown in FIG. 11 in more detail as compared with the information in the right lower half display region 1103 shown in FIG. 11. General investors 1504 can consult these displayed contents for their decisions to investment.

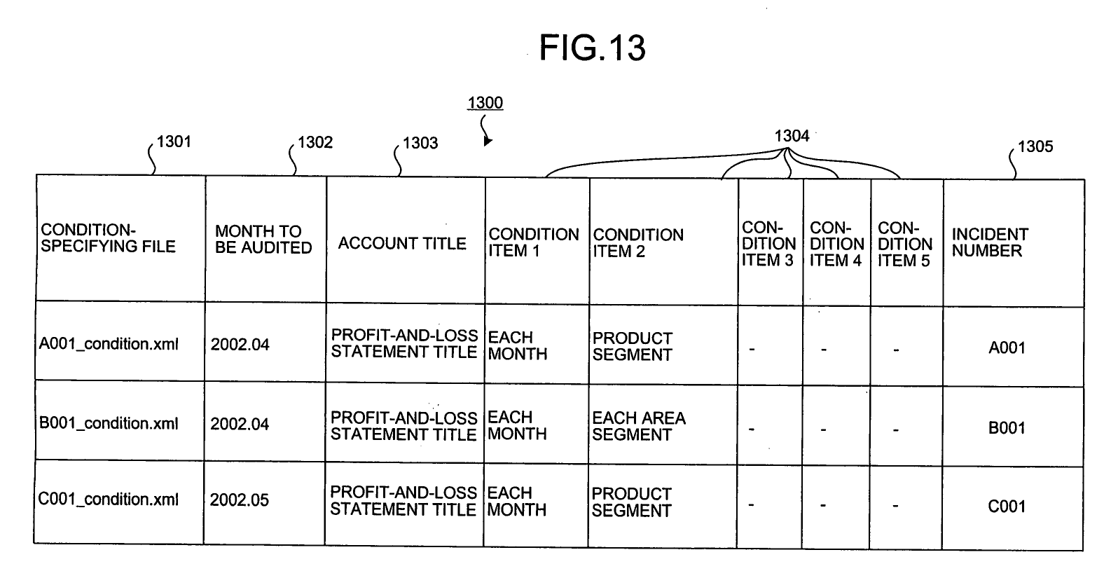

FIG. 13 is a diagram of a condition-specifying file. The condition-specifying file is for specifying a condition(s) corresponding to an information element of information elements to be disclosed that a general investor requires. A required Data element(s) can be extracted from the accounting system 103 of the public company 1502 by setting up the file.

The condition-specifying file 1300 includes “condition-specifying file” 1301 showing a name of a condition-specifying file, “month to be audited” 1302 showing a specific condition, “account item” 1303, a plurality of “condition items” 1304, and “incident number” 1305. Therefore, the incident number is given to each segment information obtained by segmenting information to be disclosed.

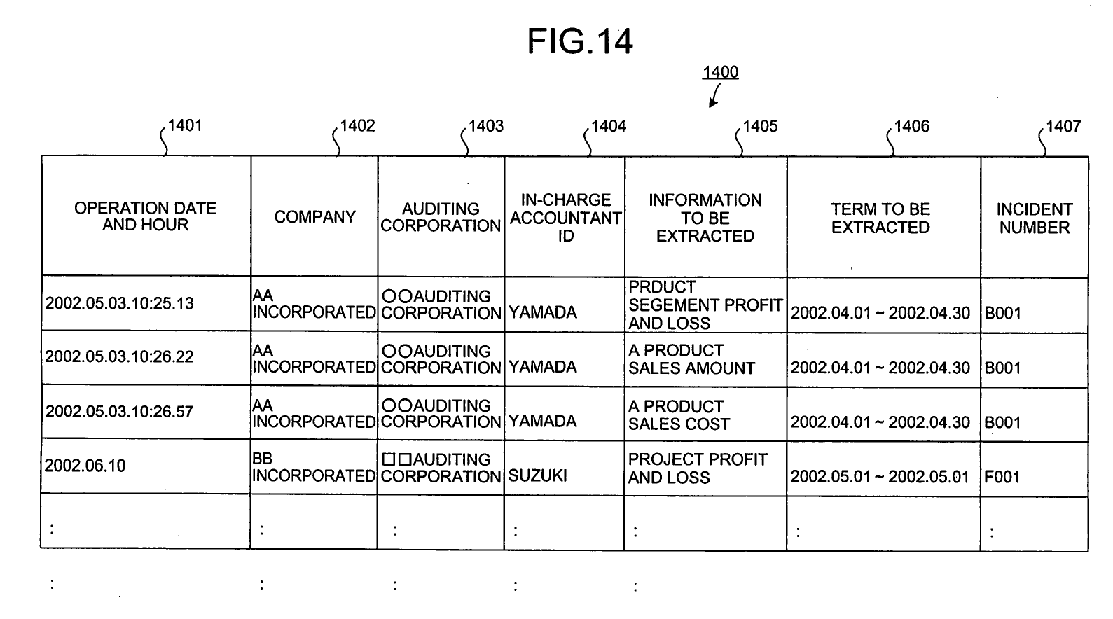

FIG. 14 is a diagram a log file. A log file is a file for recording operation status of certification issuance request for each incident number operated by the audit system 104. A log file 1400 includes “operation date and hour” 1401, “company” 1402 showing information on a company name to be accessed by the auditing system 104, “auditing corporation” 1403 showing information on an auditing corporation/certified public accountant operating the auditing system 104 and “in-charge accountant ID” 1404, “information to be extracted” 1405 regarding information extracted by the auditing system 104 and “term to be extracted” 1406, and “incident number” 1407. Contents of the auditing system 104 will be explained in detail below.

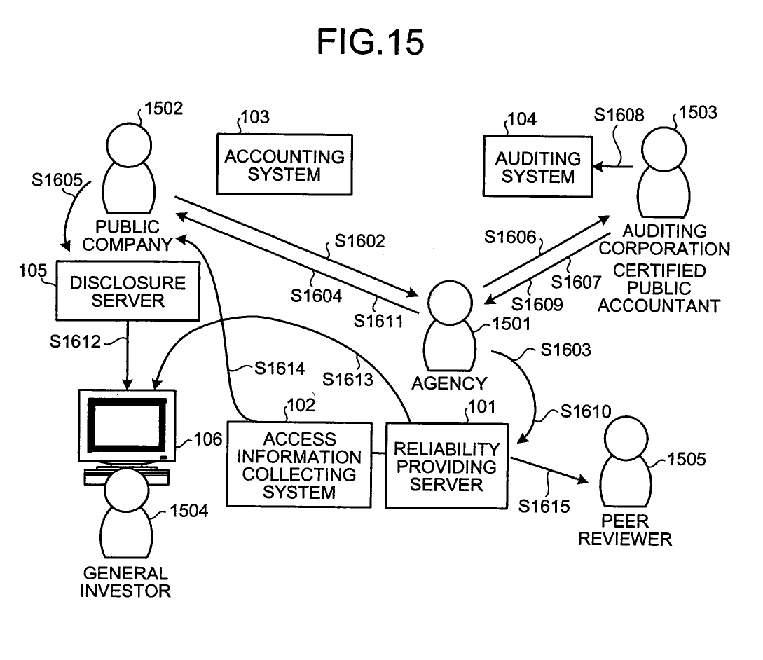

FIG. 15 is a diagram for explaining a reliability providing processing. Numeral 1501 denotes an agent, numeral 1502 denotes a public company, numeral 1503 denotes an auditing corporation or a certified public accountant, numeral 1504 denotes a general investor, and numeral 1505 denotes a peer reviewer. The peer reviewer 1505 may be Institute of Certified Public Accountants, a regulatory authority in government, an auditing corporation/certified public accountant, or the like.

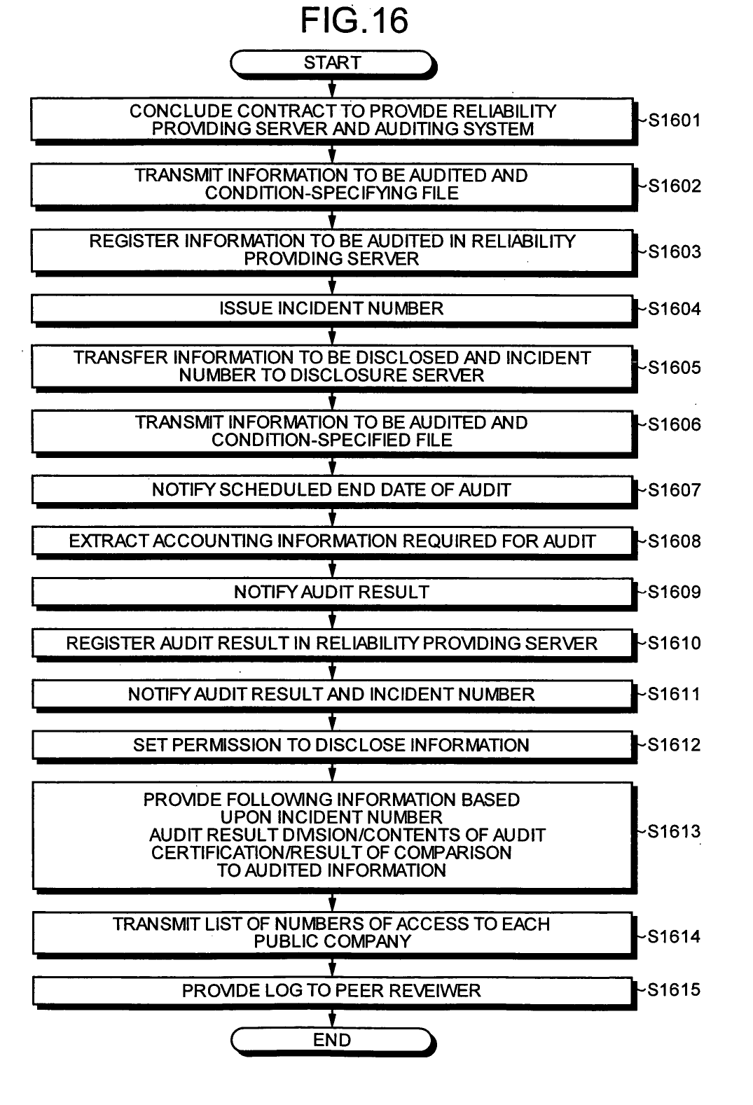

FIG. 16 is a flowchart of the reliability providing processing. A contact for providing a reliability providing sever and an auditing system 104 is concluded (step S1601). Specifically, an auditing corporation/certified public accountant 1503 concludes a list registration contract and an auditing system use contract with an agent 1501, and the agent 1501 registers the auditing corporation/certified public accountant 1503 in a list. A public company 1502 concludes an audit certification contract and an auditing system use contract with the agent 1501. The public company 1502 selects an auditing corporation/certified public accountant 1503 from the list of the agent 1501 to conclude audit contract with the selected one. The agent 1501 manages such information in the audit contract table shown in FIG. 4.

Thereafter, the public company 1502 sends information to which issuance of an audit certification is desired and its condition-specifying file (electronic data) to the agent 1501 (step S1602). Specifically, information to which the audit certification is desired may include segment information for each month and for each product, segment information for each month and for each area, year-on-year profit and loss information, and the like, and the condition-specifying file is a file that can be read/identified by the audit system 1 and includes condition for extracting the information to which an audit certification is desired.

The agent 1501 receives the information to which an audit certification is desired and the condition-specifying file and registers them in the reliability providing server 101 (step S1603). The agent 1501 issues an incident number to the received information to which an audit certification is desired (step S1604), and starts information management about whether the audit certification has been terminated using the audit certification information processing table shown in FIG. 5 (see information indicated by the incident number “B001” shown in FIG. 5). The agent 1501 notifies the incident number to the public company 1502 just after issuance of the incident number.

The public company 1502 transfers the received incident number along with the information whose disclosure is desired, namely, the information to which an audit certification is desired to the disclosure server 105 (step S1605). The information disclosure table shown in FIG. 9 in the disclosure server 105 stores, for each information, a menu name, an incident number, and whether to disclose the information. Specifically, a person in charge determines to disclose only audited information, and rewrites the information disclosure table. A program running on the disclosure server 105 checks “disclosure permission” in the information disclosure table at any time, and it constructs a menu including only items indicated with “permitted”. The menu is shown in FIG. 11.

The agent 1501 sends the information to which an audit certification is desired, the condition-specifying file (FIG. 13), and the incident number to the auditing corporation/certified public accountant 1503 (step S1606). The auditing corporation/certified public accountant 1503 notifies a scheduled end date of audit to the agent 1501 (step S1607). As shown in FIG. 6, the auditing corporation/certified public accountant 1503 changes “status” in the status table from “not requested for audit” to “now auditing” to update information about “scheduled end date of audit”.

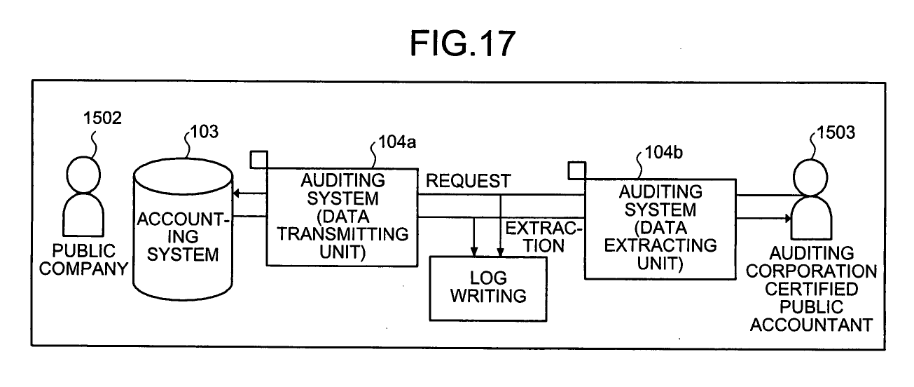

The auditing corporation/certified public accountant 1503 receives the information to which an audit certification is desired and the condition-specifying file from the agent 1501 to starts auditing (step S1608). The auditing corporation/certified public accountant 1503 accesses the accounting system 103 of the public company utilizing the auditing system 104 provided by the agent 1501 to extract information required for auditing and auditing. An auditing system 104 shown in FIG. 17 and described later can extract an information element(s) to be subjected to audit certification based on the condition-specifying file.

The auditing corporation/certified public accountant 1503 forwards (notifies) the incident number and the audit result file of financial information (electronic data) to the agent 1501 after all the auditing processing is terminated (step S1609). The agent 1501 registers the received audit result in the reliability providing server 101 (step S1610). Specifically, the agent 1501 rewrites “status”, “type of audit result”, “file name of detailed audit result” in the status table shown in FIG. 7 based upon the incident number. Further, the agent 1501 notifies the audit result and the incident number to the public company 1502 (step S1611).

The public company 1502 received the notification in step S1611 writes “disclosure permission” in the information disclosure table to “permitted”. Thereby, one indicated by “permitted” rewritten in the item “disclosure permission” in the information disclosure table, specifically, an item “for each month and for each area” in the menu on the display screen shown in FIG. 11 is added. Thus, information disclosure is conducted (step S1612).

Further, the auditing corporation/certified public accountant 1503 compares information about contents of the audit result section/audit certification and information audited with each other based upon the incident number to provide information for guaranteeing that there is not any error (step S1613). Specifically, when the general investor 1504 reaches a page of IR from a homepage of a disclosure site of the public company and clicks the menu on the display screen shown in FIG. 11, a program running on the disclosure server 105 acquires “incident number” on the information disclosure table at the clicked timing.

The program causes the incident number acquired by the program on the disclosure server 105 and the status table 500 in the reliability providing apparatus 101 to correspond to each other to acquire status/audit result section/audit certification issuance request file/detailed audit result file (if any). Further, the program checks whether there is any difference between the contents of the file of the audit certification issuance request acquired by the program on the disclosure server 105 and the contents of the file of the disclosure information in the disclosure server 105. When there is not any difference, the program displays “file of disclosure information” on the right lower half region 1103 on the display screen shown in FIG. 11. On the other hand, when there is a difference, the program displays an error to terminate the processing.

The program displays the status and the audit result section acquired by the program on the disclosure server 105 on the right lower half region 1103 on the display screen shown in FIG. 11. Simultaneously, the program on the disclosure server 105 accesses the access information collecting system 102 in the reliability providing server 101 to count up the assess number counter (see FIG. 8) for disclosure information corresponding to the incident number. Further, the program graphically displays the number in the counter on the right upper half region 1102 on the display screen shown in FIG. 11.

When the general investor 1504 clicks the detail button 1105, the program on the disclosure server 105 displays the detailed audit result file. When there is not the detailed audit result file, such a message as “there is not audit result due to non-audit state” is displayed. Simultaneously, the program on the disclosure server 105 accesses the access information collecting system 102 in the reliability providing server 101 to count up the access number counter (FIG. 8) for the detailed audit result corresponding to the incident number.

The access information collecting system 102 periodically lists up the contents of the access table shown in FIG. 8 to send the list to each public company 1502 (step S1614). The public company 1502 can determine whether its own information disclosure satisfies needs of general investors 1504 based upon the information, or can determine whether there is additional effective information to be disclosed considering disclosure information of other companies in the same trade.

Further, the agent 1501 provides log information to the peer reviewer 1505 (step S1615). The peer reviewer 1505 determines an incident number to be peer-reviewed from the incident numbers of audits performed by the auditing corporation/certified public accountant 1503 who is a revenue to request required for peer-reviewing from the incident number to the agent 1501. The agent 1501 provides the information required for peer-reviewing according to the request from the peer-reviewer 1505.

The required information may include all detailed audit result files corresponding to the incident number presented by the peer-reviewer 1505, file names of all audit certification issuance request corresponding to the incident number presented by the peer-reviewer 1505, and all data elements in a log file corresponding to the incident number presented by the peer-reviewer 1505. The peer reviewer 1505 performs peer review based upon the received information and research performed to auditing corporations individually. Thereby, the peer-reviewer 1505 can confirm whether a normal auditing has been conducted.

FIG. 17 is a diagram of an auditing system. The auditing corporation/certified public accountant 1503 logs on the auditing system (the data extracting unit 104b) using an log on ID assigned to each person in charge. The auditing corporation/certified public accountant 1503 sets up the condition-specifying file 1300 shown in FIG. 13 to the data extracting unit 104b. The data extracting unit 104b issues an extraction request to the auditing system (the data transmitting unit 104a) based upon the condition-specifying file set up and the data transmitting unit 104a receives information extracted from the accounting system 103 to display the same.

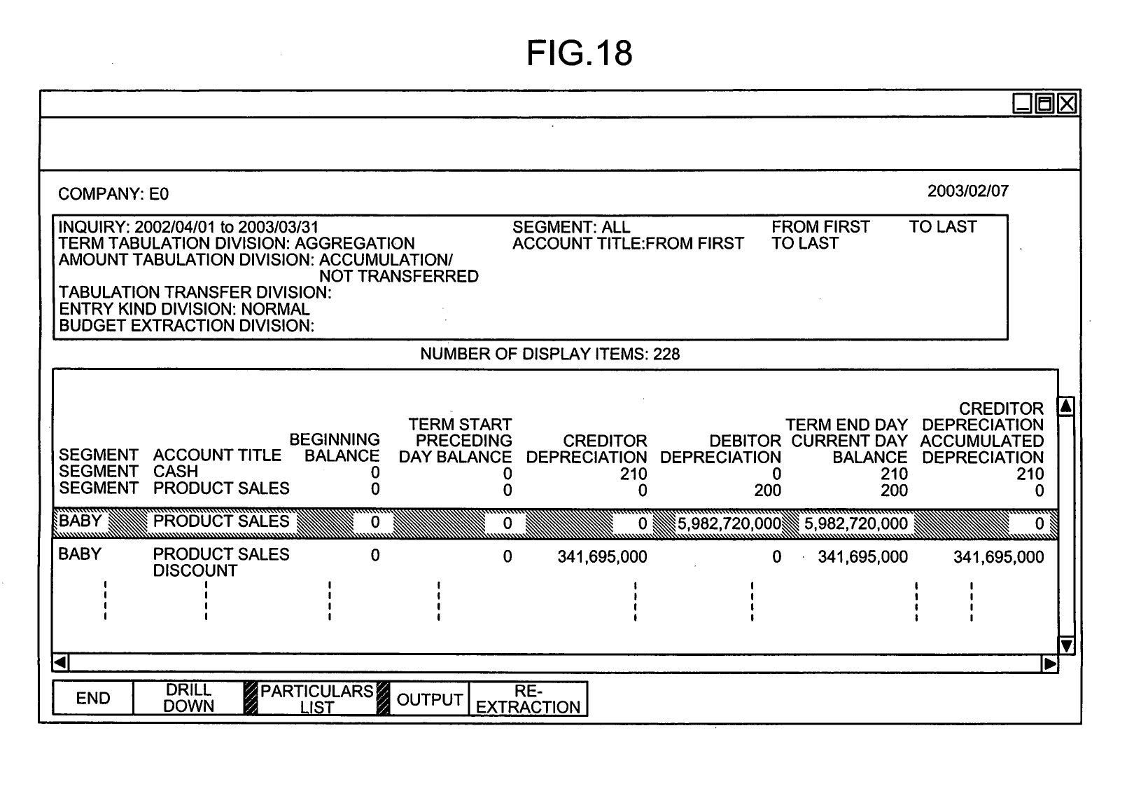

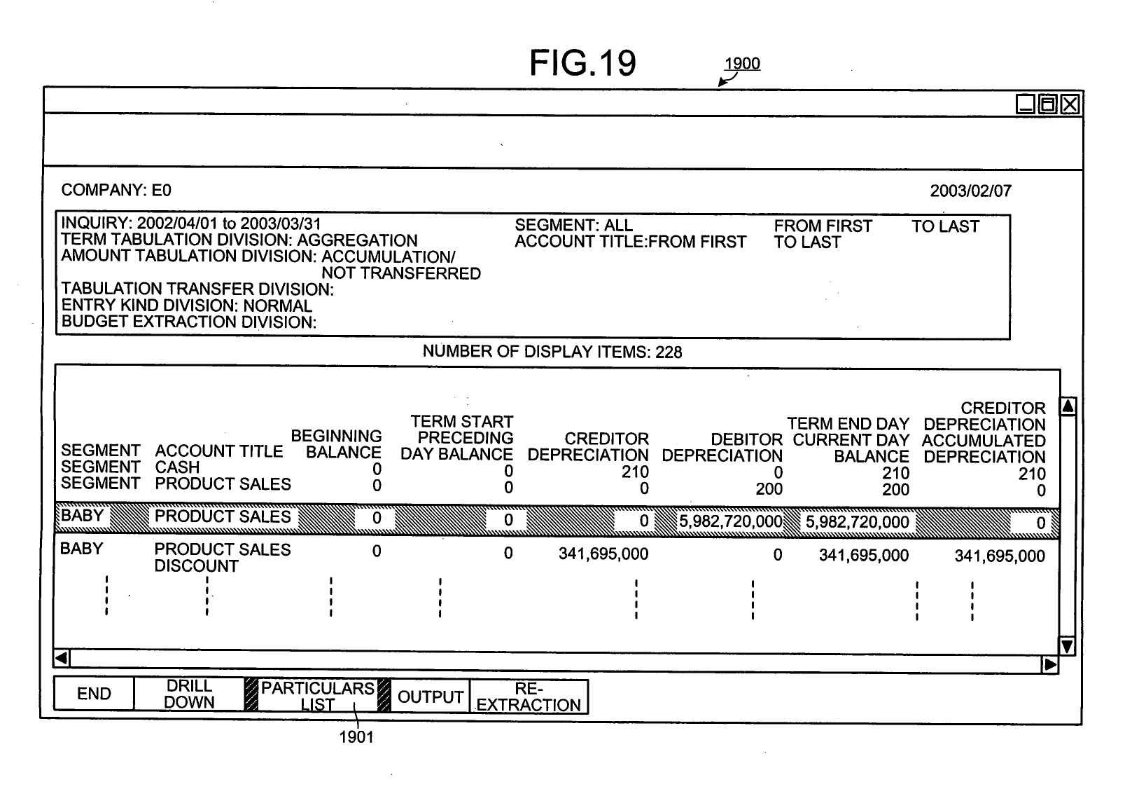

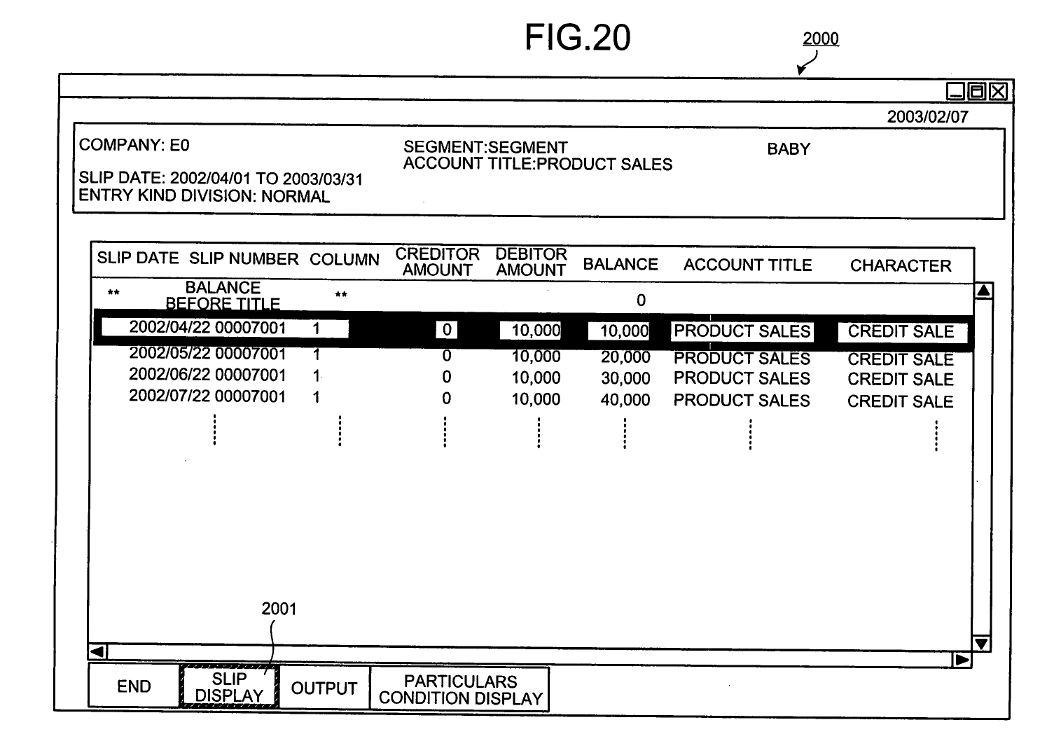

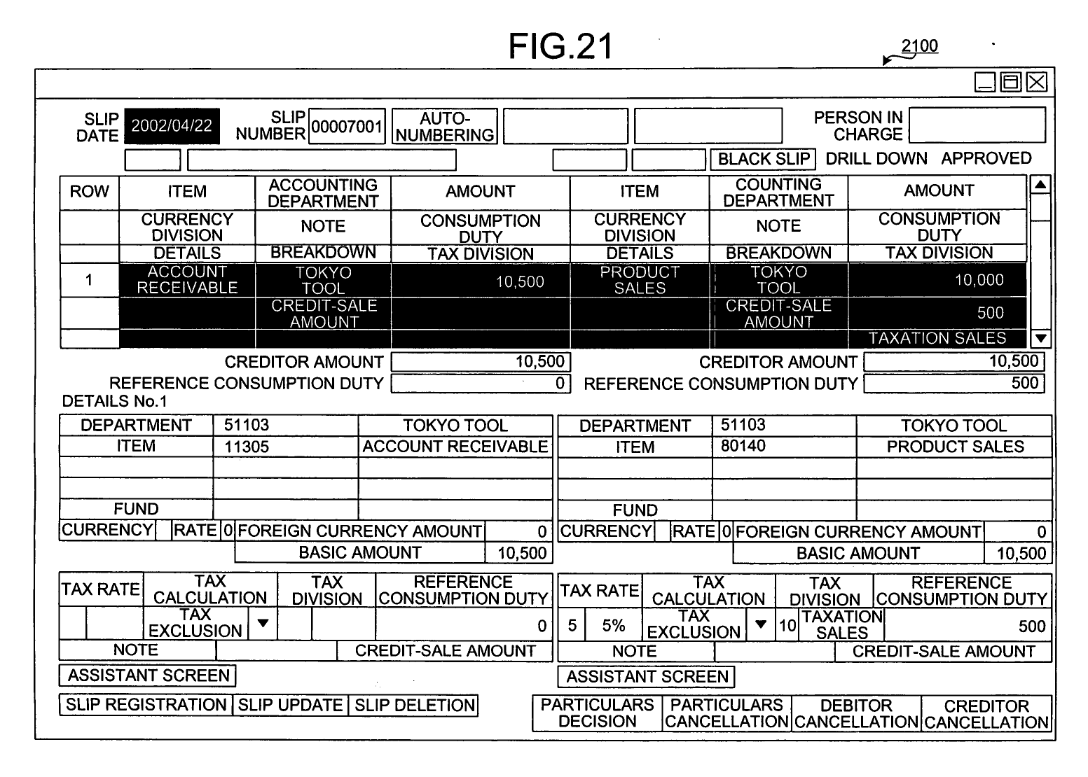

FIGS. 18 to 21 are explanatory diagrams showing one example of a display screen of the auditing system 104. FIG. 18 is a diagram of a screen showing profit and loss for each market segment. A function of being capable of performing drill down to an important item(s) to purchase a slip is provided. Such a fact that a particulars list/slip of sells of products for baby segment can be confirmed is shown in FIGS. 19 to 21 as one example. In a display screen 1900 shown in FIG. 19, when a “particulars list” button 1901 at a lower portion thereof is pushed, a display screen 2000 shown in FIG. 20 is displayed. Further, on the display screen 2000, when a “slip display” button 2001 at a lower end is pushed, a display screen 2100 showing contents on a slip is displayed. Similarly, a balance statement or the like can be displayed in addition to the slip display. Since required information can be rapidly displayed according to a simple operation, a time for auditing processing can be reduced. The auditing system 104 is provided with a function that writes respective requests/extractions to the log file shown in FIG. 14. The items written into the log file are as shown in FIG. 14.

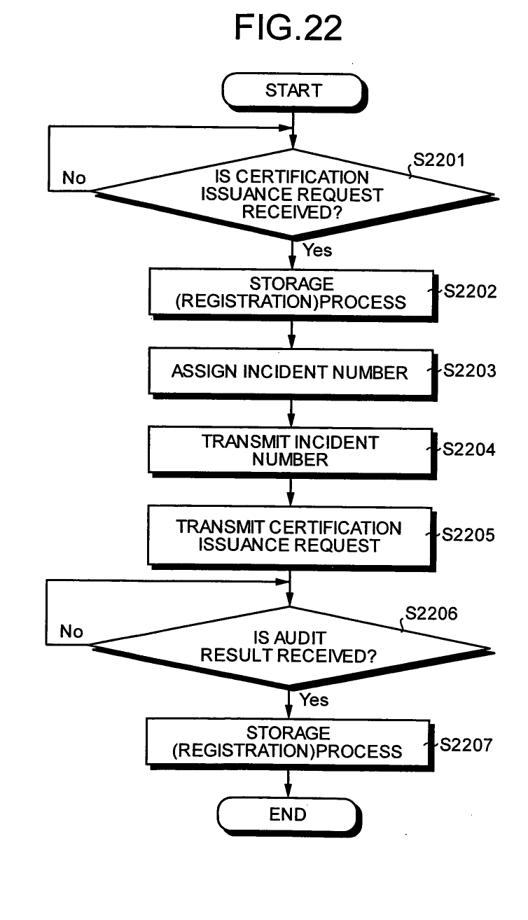

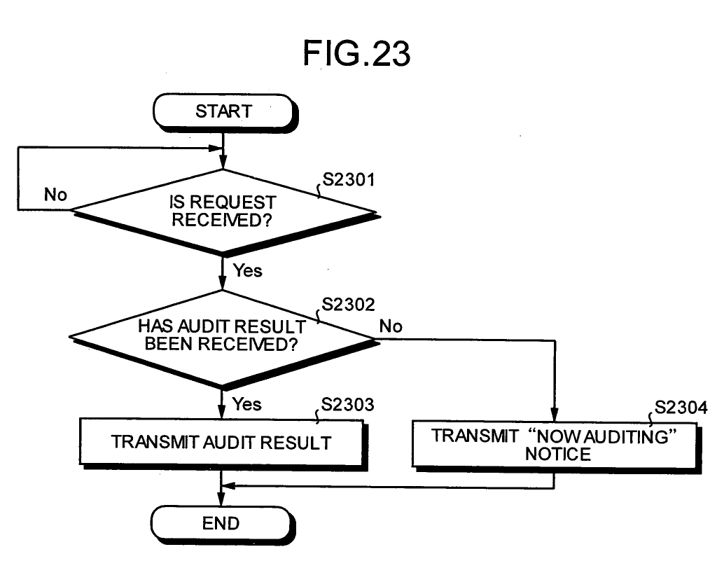

FIGS. 22 and 23 are flowcharts of a processing performed by the reliability providing server 101. In the flowchart shown in FIG. 22, first, whether the reliability providing server 101 receives certification issuance request from a public company 1502 (an accounting system 103) is determined (step S2201). When the reliability providing server 101 waits for reception and receives the certification issuance request (“YES” at step S2201), it performs a storage (registration) processing of the received certification issuance request (step S2202).

The reliability providing server 101 gives an incident number to the received certification issuance request (step S2203) and transmits information about the given incident number to a disclosure server 105 (step S2204). The reliability providing server 101 transmits the received certification issuance request to the auditing system 104 (step S2205). Thereafter, the reliability providing server 101 waits for reception of audit result from the auditing system 104 (step S2206), and when receiving the information (“YES” at step S2206), the reliability providing server 101 performs storage (registration) processing of the received audit result (step S2207) to terminate a series of processings.

In the flowchart shown in FIG. 23, whether the reliability providing server 101 receives request from the disclosure server 105 is determined (step S2301), and when the reliability providing server 101 waits for reception and receives a request (“YES” at step S2301), it determines whether the reliability providing server 101 has received the audit result about the incident number corresponding to the received request from the auditing system 104 (step S2302). When the reliability providing server 101 has received the audit result (“YES” at step S2302), it transmits the audit result to the disclosure server 105 (step S2303). On the other hand, when the reliability providing server 101 has not received the audit result yet (“NO” at step S2302), it transmits a notice indicating “now auditing” to the disclosure server 105 (step S2304) to terminate a series of processing.

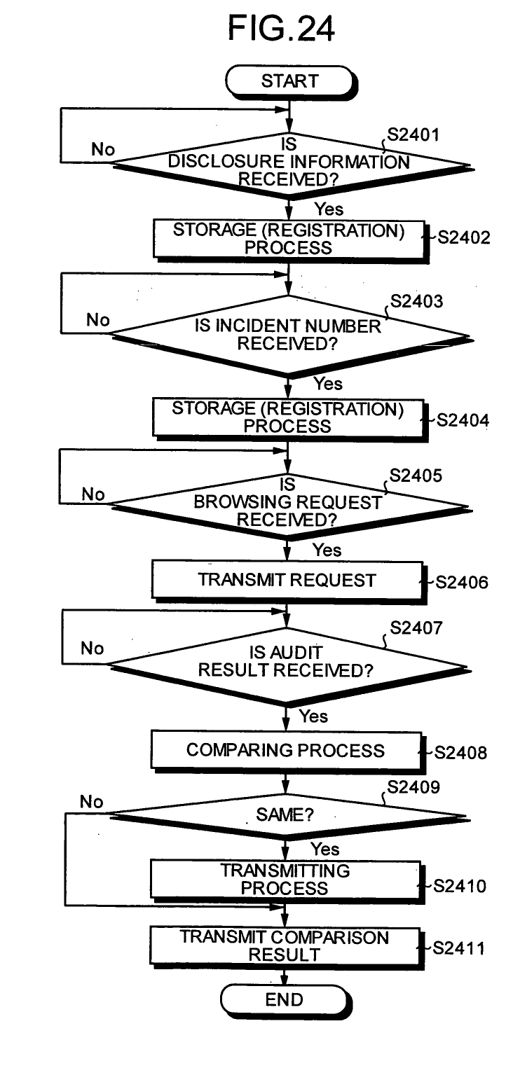

FIG. 24 is a flowchart of a processing performed by the disclosure server 105. In the flowchart shown in FIG. 24, first, the disclosure server 105 determines whether it has received disclosure information from a public company 1502 (an accounting system 103) (step S2401). When the disclosure server 105 waits for reception to receive disclosure information (“YES” at step S2401), it performs storage (registration) processing of the received disclosure information (step S2402).

The disclosure server 105 determines whether it has received an incident number from the reliability providing server 101 (step S2403). When the disclosure server 105 waits for reception and receives the incident number (“YES” at step S2403), it performs storage (registration) processing of the received incident number in association with the disclosure information (step S2404).

Thereafter, the disclosure server 105 waits for a browsing request for disclosure information from the client 106 of a general investor 1504, and when receiving a browsing request (“YES” at step S2405), the disclosure server 105 transmits request for the audit result to the reliability providing server 101 (step S2406). The disclosure server 105 determines whether it has received the audit result on the audit result (including the certification issuance request stored in the reliability providing server 101) from the reliability providing server 101 (step S2407). When waiting for reception to receive the audit result (“YES” at step S2407), the disclosure server 105 then performs comparison processing between the stored disclosure information and the received audit result (the certification issuance request) (step S2408).

The disclosure server 105 determines whether the stored disclosure information and the received certification issuance request are coincident with each other (step S2409). When the both are coincident with each other (“YES” at step S2409), the disclosure server 105 performs a transmitting processing of the disclosure information and the audit result to the client 106 (step S2410). Thereafter, the disclosure server 105 transmits comparison result to the reliability providing server 101 (step S2411) to terminal a series of processing. On the other hand, when both the stored disclosure information and the received audit result are not coincident with each other at step S2409 (“NO” at step S2409), the disclosure server 105 transmits comparison result to the reliability providing server 101 without performing transmitting processing (step S2411) to terminate the series of processings. Incidentally, the disclosure server 105 may perform the transmitting processing at step S2410 without performing the comparison processing at steps S2408 and S2409.

As explained above, according to the embodiment, a public company can be evaluated at its optimal time by a general investor(s). Monthly disclosure can be performed according to step S1615 shown in FIG. 16. Since the self-disclosure information is audited information, a general investor(s) can determine its appropriateness, so that he/she (they) can trust the self-disclosure information of the public company. Since a general investor(s) can perform a procedure regarding accounting information registered in the accounting system 103 according to the auditing system 104 without visiting the public company, an auditing term can be reduced as compared with the conventional technique and auditing can be performed monthly.

Since there is means for certifying that information is audited information, when information published as audited one by a public company is different from information actually audited, a general investor(s) can confirm such a fact. A chance where a certified public accountant/auditing corporation catches an audit business can be expanded by movement from the conventional six-monthly auditing to a monthly auditing.

Since portion of information required for peer reviewing can be acquired in detail from access log of the auditing system 104, efficiency of peer review is improved and accuracy is also improved. A peer review is essential for an auditing corporation/certified public accountant registered according to the embodiment. Accordingly, a general investor(s) can place stronger trust in an auditing corporation registered in the system of the present invention than an auditing corporation in the conventional technique so that he/she (they) can trust a self-disclosure information of a public company more highly as compared with the conventional self-disclosure information.

As explained above, according to the present invention, a reliability providing method, an information disclosing method, a reliability providing program, an information disclosing program, a reliability providing apparatus, and an information disclosing apparatus providing audit and reliability to self-disclosure accounting information of a public company to realize a proper stock price formation demand.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A server for providing an audit certificate for investor-relations-information to a disclosure server of a public company in cooperation with an audit server, the server comprising:
an audit-request-receiving unit that receives an audit request for an audit of the investor-relations-information from the public company;
an audit-request-sending unit that sends the audit request received from the public company to the audit server;
an audit-certificate-receiving unit that receives the audit certificate including a result of the audit from the audit server;
an audit-certificate-request-receiving unit that receives an audit certificate request for the audit certification from the disclosure server; and
an audit-certificate-sending unit that sends the audit certificate to the disclosure server in response to the audit certificate request.

2. The server according to claim 1, wherein
the audit-certificate-sending unit sends the audit certificate when the audit certificate has been received, and otherwise sends a notice for notifying that the audit certificate has not been received yet, to the disclosure server in response to the audit certificate request.

3. The server according to claim 1, wherein
the audit-certificate-sending unit sends the audit certificate and the audit request received from the disclosure server to the disclosure server in response to the audit certificate request.

4. The server according to claim 1, further comprising an identification-number-assigning unit that assigns an identification number to each of the audit request, wherein
the audit certificate request includes the identification number assigned to the investor-relations-information for which the audit certificate is requested.

5. A method for a server that provides an audit certificate for investor-relations-information to a disclosure server of a public company in cooperation with an audit server, the method comprising:
receiving an audit request for an audit of the investor-relations-information from the public company;
sending the audit request received from the public company to the audit server;
receiving the audit certificate including a result of the audit from the audit server;
receiving an audit certificate request for the audit certification from the disclosure server; and
sending the audit certificate to the disclosure server in response to the audit certificate request.

6. The method according to claim 5, wherein
the sending the audit certificate includes sending the audit certificate when the audit certificate has been received, and otherwise sending a notice for notifying that the audit certificate has not been received yet, to the disclosure server in response to the audit certificate request.

7. The method according to claim 5, wherein
the sending the audit certificate includes sending the audit certificate and the audit certificate request received from the disclosure server to the disclosure server in response to the audit certificate request.

8. The method according to claim 5, further comprising assigning an identification number to each of the audit request, wherein
the audit certificate request includes the identification number assigned to the investor-relations-information for which the audit certificate is requested.

9. A computer-readable recording medium that stores a computer program to cause a server, which provides an audit certificate for investor-relations-information to a disclosure server of a public company in cooperation with an audit server, to execute:
receiving an audit request for an audit of the investor-relations-information from the public company;
sending the audit request received from the public company to the audit server;
receiving the audit certificate including a result of the audit from the audit server;
receiving an audit certificate request for the audit certification from the disclosure server; and
sending the audit certificate to the disclosure server in response to the audit certificate request.
